(19) United States
(12) Patent Application Publication
(10) Pub. No.: US 2026/0194930 A1
(43) Pub. Date: Jul. 9, 2026

(54) REDUNDANT CONTROLLERS TO IMPROVE ROBUSTNESS IN VOLTAGE REGULATION MODULES

(71) Applicant: International Business Machines Corporation, Armonk, NY (US)

(72) Inventors: Francesca Felisa Andrada, Rochester, MN (US); Luxing Wang, Cedar Park, TX (US); Eric B. Swenson, Pine Island, MN (US); Justin E. Henspeter, Georgetown, TX (US)

(21) Appl. No.: 19/010,275

(22) Filed: Jan. 6, 2025

(51) Int. Cl. G05F 1/569; G05F 1/575

(52) U.S. Cl. CPC G05F 1/569; G05F 1/575

(57) ABSTRACT

Embodiments of the disclosure relate to redundant controllers to improve design robustness in voltage regulation modules. Aspects include detecting, by a control switch, a failure of a first controller of a first circuit, the first circuit controlling power output from at least one phase. Aspects include initiating, by the control switch, a second controller of a second circuit to retrieve an image for operating the at least one phase. Aspects include receiving, from the second controller, a control signal having commands for operating the at least one phase based on the image.

### BACKGROUND

The present disclosure generally relates to computer systems, and more specifically, to computer-implemented methods, computer systems, and computer program products configured and arranged for employing redundant controllers to improve design robustness in voltage regulation modules and point-of-load (POL) applications.

Voltage regulation modules (sometimes referred to as “VRMs”) are used in many electronics systems to provide voltage and current to various electronics components according to the requirements of those components. VRMs typically are composed of at least one semiconductor switch (e.g., a MOSFET switch) and at least one inductor (sometimes referred to as a “choke”). Some VRMs also include capacitors located near the inductors or near the components to which the VRMs are delivering power. The VRM components that together provide voltage and current (e.g., a MOSFET switch and inductor pair) are often referred to collectively as a “power stage.” These VRM components are often controlled by a circuit referred to as controller (sometimes referred to as a “VRM controller”).

The VRM controller is used to control the components of the VRM to deliver current at a given voltage. When a VRM controller closes a semiconductor switch (e.g., turning on the power stage), for example, current flows through the VRM. The inductor of the VRM slows the change in voltage at the VRM output as a result of this current, preventing unwanted voltage spikes or drops in the power delivered to the system components. Some VRMs also include capacitors, which can smooth out the power output by the VRM, preventing “ripples” in the voltage that can be caused by, for example, conversion between multiple voltages or by electronic noise in the system.

### SUMMARY

Embodiments of the disclosure include a computer-implemented method for employing redundant controllers to improve design robustness in voltage regulation modules and point-of-load (POL) applications. The method includes detecting, by a control switch, a failure of a first controller of a first circuit, the first circuit controlling power output from at least one phase and initiating, by the control switch, a second controller of a second circuit to retrieve an image for operating the at least one phase. The method includes receiving, from the second controller, a control signal having commands for operating the at least one phase based on the image.

According to one or more embodiments, a system includes a first circuit having a control switch and a first controller, and a plurality of circuits, the first circuit being included in the plurality of circuits. The control switch is configured to detect a failure of the first controller of the first circuit, the first circuit controlling power output from at least one phase. The control switch is configured to initiate a second controller of a second circuit of the plurality of circuits to retrieve an image for operating the at least one phase. Also, the control switch is configured to receive, from the second controller, a control signal having commands for operating the at least one phase based on the image.

The above features and advantages, and other features and advantages, of the disclosure are readily apparent from the following detailed description when taken in connection with the accompanying drawings.

### BRIEF DESCRIPTION OF THE DRAWINGS

FIG. 1 illustrates a block diagram of an example voltage regulation module or point-of-load (POL) circuit according to one or more embodiments

FIG. 2 illustrates a block diagram of example voltage regulation module circuits with phase control switches to provide redundancy in accordance with one or more embodiments.

FIG. 3 illustrates a block diagram of example voltage regulation module circuits with phase control switches to provide redundancy in accordance with one or more embodiments.

FIG. 4 illustrates a block diagram of example voltage regulation module circuits with phase control switches to provide redundancy in accordance with one or more embodiments.

FIG. 5 illustrates a block diagram of example voltage regulation module circuits with phase control switches to provide redundancy in accordance with one or more embodiments.

FIG. 6 depicts a flowchart of a computer-implemented method for providing redundant controllers in voltage regulation modules and point-of-load applications, thereby improving design robustness in accordance with one or more embodiments.

FIG. 7 illustrates a computing environment for executing methods related to providing redundant controllers to improve design robustness in voltage regulation modules and point-of-load applications in accordance with one or more embodiments.

The above features and advantages, and other features and advantages, of the disclosure are readily apparent from the following detailed description when taken in connection with the accompanying drawings.

### DETAILED DESCRIPTION

One or more embodiments are configured and arranged for employing redundant controllers to improve design robustness in voltage regulation modules and point-of-load (POL) applications.

Voltage regulator apparatuses/point-of-load applications use a single controller to control a phase or N number of phases to support low voltage/low power requirements in system. Typical controllers existing today have two loops, each with the ability to support a voltage domain controlling one to N number of phases depending on the current demands of the application. Present designs have increased the number of phases such that when one or two phases fail, the circuit can still support the current demand. However, when the controller fails, the phases cannot function, and the voltage domain fails. Moreover, when a controller fails, its phases are unusable, and its output fails.

According to one or more embodiments, because each loop can support a different voltage domain, the present disclosure utilizes a second loop (e.g., located in a separate controller) to act as a backup controller so that when the primary controller fails, the backup controller takes over the primary controller's phases and keeps the voltage domain running. This makes the design robust against single point-of-failures that occur when a controller fails. According to one or more embodiments, it is noted that the primary and backup controllers should be in separate packages so that no single failure can cause both controllers to fail. If both the primary and backup controllers are used in a single package, an additional controller should be utilized to provide a backup for each loop. Separate packages refers to separate voltage regulation module cards, separate voltage regulation module circuits, etc., which can each function independently of one another.

In accordance with one or more embodiments, the present disclosure adds circuitry and logic to (1) diagnose a defective controller, (2) connect both the primary and backup controllers to a switch that then decides which controller should be active, (3) generate a control signal indicating whether the active controller is the primary or the backup controller and (4) send the signal status to a system (e.g., a computer system).

Descriptions of various embodiments of the present disclosure are presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

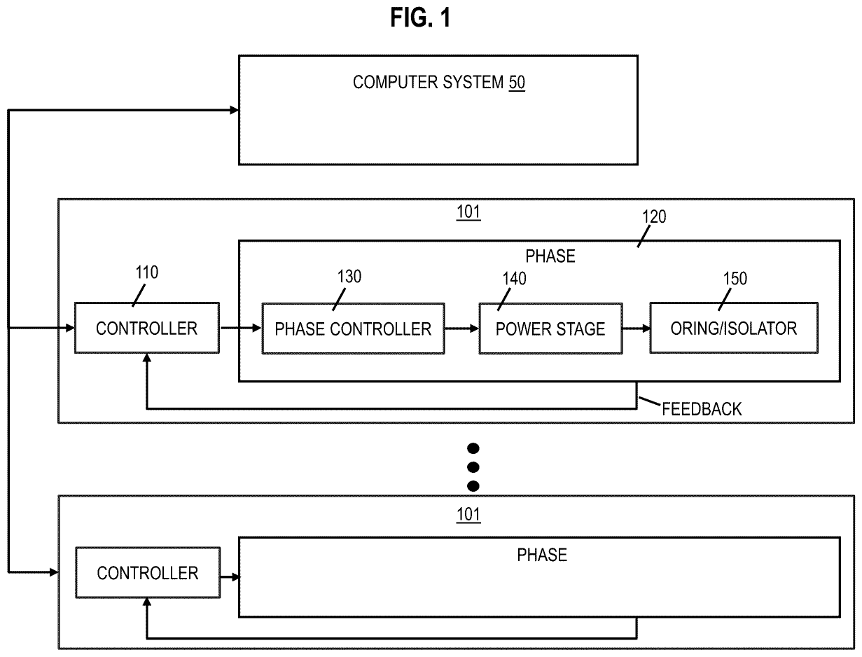

FIG. 1 depicts a block diagram of an example voltage regulation module or point-of-load (POL) circuit according to one or more embodiments. In one or more embodiments, each circuit may be configured as a pluggable voltage regulation module card 101. There can be many voltage regulation module cards 101 coupled to a computer system 50 for monitoring, which provides a human machine interface (HMI). The voltage regulation module card 101 may be referred to as a voltage regulation module.

The voltage regulation module card 101 includes a voltage regulation module controller 110 and a phase 120. The phase 120 is a circuit that includes a phase controller 130, a power stage 140, and an isolator 150 (e.g., Oring/isolator). Feedback from the phase 120 is returned back to the voltage regulation module controller 110.

The voltage regulation module controller 110 controls the phase controller 130. The voltage regulation module controller 110 is the primary control unit responsible for overseeing the entire system's operation. The voltage regulation module controller 110 typically coordinates the activities of one or more phase controllers 130 and ensures that the overall system functions correctly. The voltage regulation module controller 110 handles high-level tasks such as setting reference voltages, managing system-wide parameters, and making decisions based on feedback from the phase 120. The voltage regulation module controller 110 can also perform complex calculations and adjustments to optimize performance. The voltage regulation module controller 110 can support multiple phases as discussed herein.

The phase controller 130 typically handles more localized or specialized tasks, such as controlling individual phases in a multiphase voltage regulator. The phase controller 130 follows the commands from the primary controller and makes adjustments to its assigned phase or component. For example, the phase controllers 130 manage the switching of transistors, monitor the current and voltage of their respective phases, and make real-time adjustments based on the primary controller's commands. The phase controllers 130 provide feedback to the voltage regulation module controller 110.

The power stage 140 includes the components and circuitry responsible for converting electrical energy from one form to another and delivering it to the load (not shown). The power stage 140 may be the final circuit section within a power converter that performs the actual power conversion, typically consisting of switching devices like transistors (MOSFETs or IGBTs), capacitors, and inductors, responsible for transforming the input voltage to the desired output voltage level. The power stage 140 can include DC to DC converts.

The isolator 150 acts to break the path if the desired phase is damaged. The phases 120 provide power to loads (not shown). It is noted that control lines are illustrated for providing control signals that control the flow of electricity. For the sake of brevity and not to obscure the figures, the power lines, which carry the power, are not illustrated for providing power to and from the phases 120.

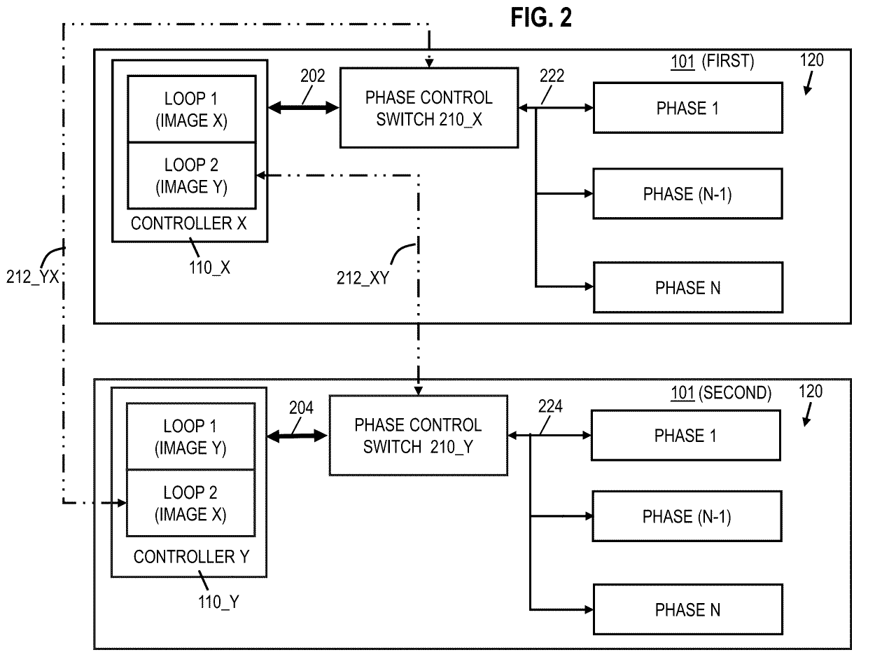

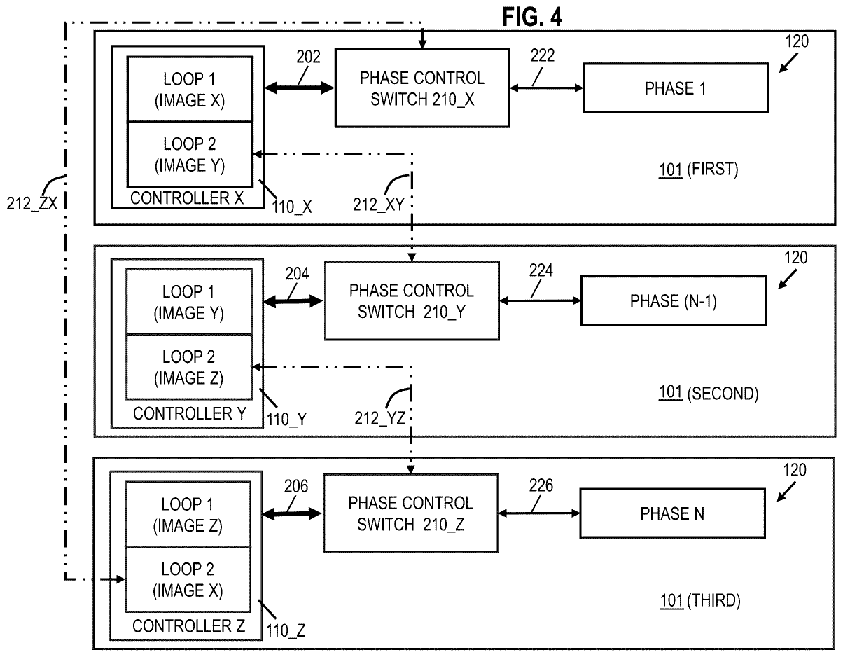

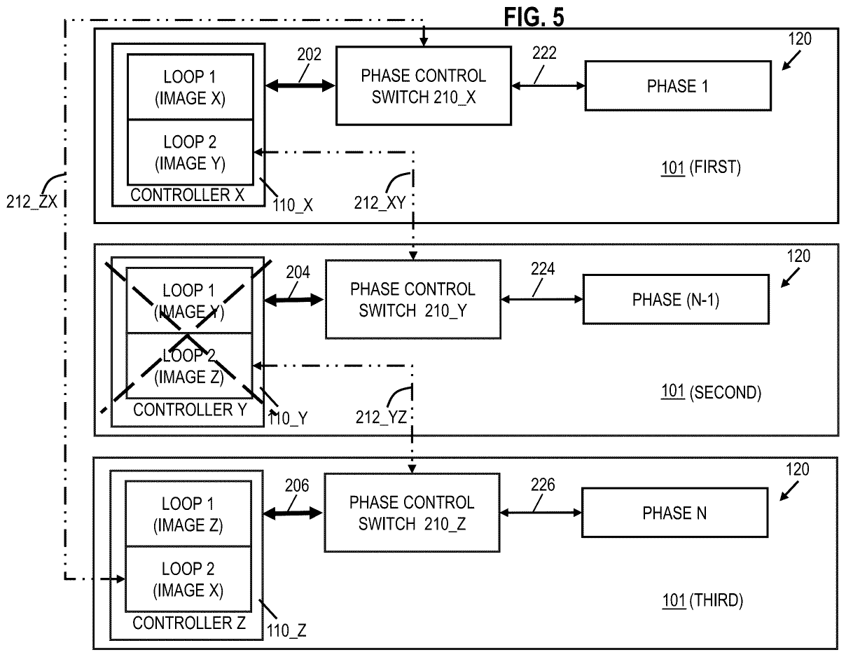

FIG. 2 depicts a block diagram of example voltage regulation module circuits with phase control switches to provide redundancy according to one or more embodiments. Although only two voltage regulation module cards 101 are shown, there can be more than two voltage regulation module cards 101. FIG. 2 depicts representations of many voltage regulation module controllers 110 that are illustrated as voltage regulation module controller 110_X (e.g., controller X), voltage regulation module controller 110_Y (e.g., controller Y), and voltage regulation module controller 110_Z (e.g., controller Z depicted in FIGS. 4 and 5). Each voltage regulation module card 101 has its own voltage regulation module controller that can control 1-N phases 120, where N represents the last phase. The voltage regulation module controllers 110 each include loop 1 and loop 2.

In the voltage regulation module controllers 110, a loop refers to a control loop used to regulate the output voltage and current. Control loops maintain the desired performance and stability of the system. There are typically two main types of control loops in voltage regulators, which are the voltage control loop and the current control loop.

The voltage control loop is designed to maintain a stable output voltage by adjusting the control signals to the power stage components (e.g., switching transistors). The loop continuously monitors the output voltage and compares it to a reference voltage. If there is any deviation from the desired output voltage, the control loop makes real-time adjustments to bring the output voltage back to the reference/target value. The voltage control loop typically includes a voltage feedback sensor, an error amplifier, a compensator, and a pulse-width modulation (PWM) controller. The feedback sensor measures the output voltage, the error amplifier compares it to the reference voltage, and the compensator and PWM controller adjust the switching of the power stage to correct any errors.

The current control loop is designed to regulate the output current, ensuring it remains within safe and desired levels. Similar to the voltage control loop, the current control loop continuously monitors the output current and compares it to a reference current. Any deviation from the desired current level is corrected by adjusting the control signals to the power stage. The current control loop typically includes a current feedback sensor, an error amplifier, a compensator, and a PWM controller. The feedback sensor measures the output current, the error amplifier compares it to the reference current, and the compensator and PWM controller adjust the switching of the power stage to maintain the desired current level.

In the voltage regulation module controller 110, the loop 1 has an image and the loop 2 has a different image according to one or more embodiments. For the loops 1 and 2, one of the images in a loop includes the parameters for operating one or more phases on the current voltage regulation module card while the other image in the other loop includes the parameters for operating one or more phases on another voltage regulation module card. One or more embodiments have added a phase control switch and additional control wires to connect the phase control switch with its current voltage regulation module card and another voltage regulation module card. Example parameters of the images of the loops may include reference current, reference voltage, temperature, PWM values, duty cycle ratio, output voltage, output current, temperature, etc.

The phase control switch (e.g., such as phase control switch 210_X, 210_Y, 210_Z depicted in FIGS. 1, 2, 3, 4, and 5) includes software and hardware including memory, processing circuitry, etc., to operate as discussed herein. The phase control switch includes logic to operate as discussed herein, and the logic can be implemented in various suitable forms. The phase control switch may include logic implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the phase control switch can be a combination of hardware and programming. The programming can be processor executable instructions stored on a tangible memory, and the hardware can include processing circuitry for executing those instructions. Thus, a memory can store program instructions that when executed by processing circuitry implement operations described herein. In one or more embodiments, the phase control switch can include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

FIG. 2 illustrates a first voltage regulation module card 101 having a phase control switch 210_X and a second voltage regulation module card 101 having a phase control switch 210_Y. As will be seen herein, FIGS. 4 and 5 depict a third voltage regulation module card 101 having a phase control switch 210_Z. The demarcation of first, second, and third voltage regulation module cards 101 are not meant for limitation but to assist the reader. The phase control switches 210_X, phase control switch 210_Y, and phase control switch 210_Z can generally be referred to as phase control switches 210.

In FIG. 2, the phase control switch 210_X is added between the voltage regulation module controller 110_X (e.g., controller X) and the phases 120 (e.g., phase 1, phase N-1, and phase N) on the first voltage regulation module card 101. Control wire 202 connects the phase control switch 210_X to the voltage regulation module controller 110_X while control wires 222 connect the phase control switch 210_X to the phases 120.

Similarly, the phase control switch 210_Y is added between the voltage regulation module controller 110_Y (e.g., controller Y) and the phases 120 (e.g., phase 1, phase N-1, and phase N) on the second voltage regulation module card 101. Control wire 204 connects the phase control switch 210_Y to the voltage regulation module controller 110_Y while control wires 224 connect the phase control switch 210_Y to the phases 120.

In this example, the voltage regulation module controller in one voltage regulation module card 101 serves as a backup to the voltage regulation module controller in another voltage regulation module card 101. In the first voltage regulation module card 101, the voltage regulation module controller 110_X (e.g., controller X) includes loop 1 with image X (e.g., its own image) for controlling its phases 120 and loop 2 with image Y (e.g., backup image) for controlling the phases 120 of the second voltage regulation card 101. Similarly, in the second voltage regulation module card 101, the voltage regulation module controller 110_Y (e.g., controller Y) loop 1 with image Y (e.g., its own image) for controlling its phases 120 and loop 2 with image Z (e.g., backup image) for controlling the phases 120 of the first voltage regulation card 101.

For example, by the loop 2, the voltage regulation module controller 110_X in the first voltage regulation module card 101 serves as a backup controller to the voltage regulation module controller 110_Y in the second voltage regulation module card 101. Similarly, by loop 2, the voltage regulation module controller 110_Y in the second voltage regulation module card 101 serves as a backup controller to the voltage regulation module controller 110_X in the first voltage regulation module card 101. This is facilitated by having (all) control signals for operation passing through the phase control switch, which is configured to switch between the primary voltage regulation module controller on the same voltage regulation module card as the phases and the secondary (backup) voltage regulation module controller on the next voltage regulation module card.

As seen in FIG. 2, a control wire 212_XY connects the voltage regulation module controller 110_X (e.g., controller X) on the first voltage regulation module card 101 to the phase control switch 210_Y on the second voltage regulation module card 101. Similarly, a control wire 212_YX connects the voltage regulation module controller 110_Y (e.g., controller Y) on second voltage regulation module card 101 to the phase control switch 210_X on the first voltage regulation module card 101.

During normal operation, the phase control switch 210_X connects loop 1 of the voltage regulation module controller 110_X (e.g., controller X) to the phases 120 on the first voltage regulation module card 101, while unused loop 2 (e.g., idle) is wired such that it is also connected to the phase control switch 210_X but not to the phases 120. During normal operation, the phase control switch 210_Y connects loop 1 of the voltage regulation module controller 110_Y (e.g., controller Y) to the phases 120 on the second voltage regulation module card 101, while unused loop 2 (e.g., idle) is wired such that it is also connected to the phase control switch 210_Y but not to the phases 120.

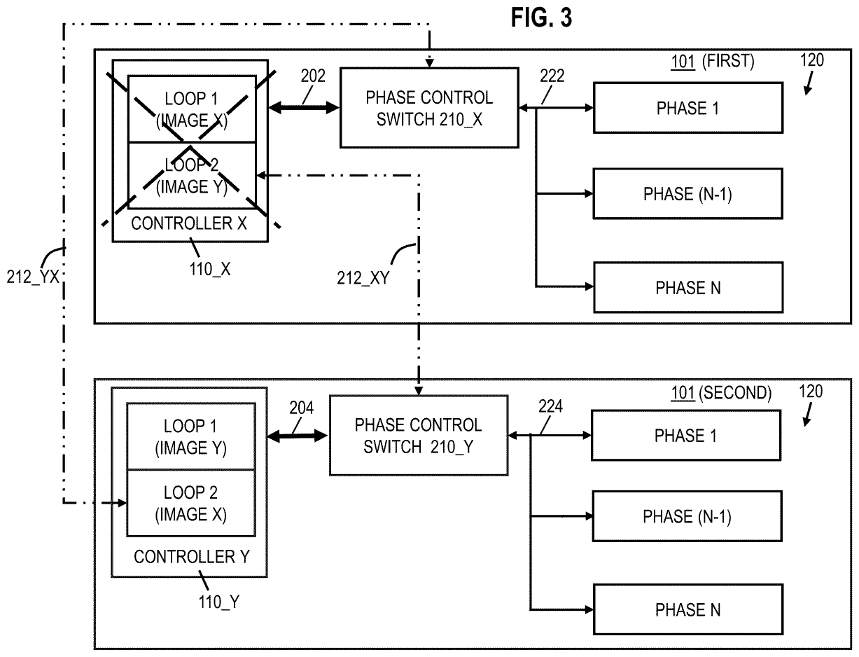

Now turning to FIG. 3, a block diagram depicts an example in which the voltage regulation module controller 110_X (e.g., controller X) fails on the first voltage regulation module card 101 and the backup controller in the second voltage regulation module card 101 is activated to control the phases 120 on the first voltage regulation module card 101. In this example, when voltage regulation module controller 110_X (e.g., controller X) fails, the phase control switch 210_X detects the failure and diagnoses voltage regulation module controller 110_X as defective. The phase control switch can detect of the failure can be implemented using any suitable technique. In one or more embodiments, the phase control switch 210_X can run a diagnostic on the voltage regulation module controller 110_X to detect the failure, can send a test control signal and fail to receive a ready control signal from voltage regulation module controller 110_X, can receive an error control signal to the voltage regulation module controller 110_X, etc. The phase control switch 210_X is configured to engage connections to voltage regulation module controller 110_Y (e.g., controller Y). The voltage regulation module controller 110_Y takes over functions of the (failed) voltage regulation module controller 110_X for backup operation. In one or more embodiments, the phase control switch 210_X may send a control signal (e.g., notification) on control wire 212_YX indicating that voltage regulation module controller 110_X has failed and voltage regulation module controller 110_Y is to take over control of the phases 120 previously controlled by voltage regulation module controller 110_X. In response to the voltage regulation module controller 110_Y receiving the control signal (e.g., as initiation) from the phase control switch 210_X, the voltage regulation module controller 110_Y is configured to retrieve the image X of loop 2 (from its memory) that corresponds to the phases 120 of the first voltage regulation module card 101 and send a control signal with commands to the phase control switch 210_X for controlling the power output of the connected phases 120.

The image X in loop 2 of the voltage regulation module controller 110_Y is a replica of the image X in loop 1 in the failed voltage regulation module controller 110_X. In one or more embodiments, the voltage regulation module controller 110_Y can receive updates to the (backup) image X in loop 2 from the computer system 50 and/or voltage regulation module controller 110_X (e.g., up until failure) such that the image X in loop 2 of the voltage regulation module controller 110_Y is ready to backup the image X in loop 1 of the failed voltage regulation module controller 110_X. Once the backup has been initiated by the control signal from the phase control switch 210_X, the voltage regulation module controller 110_Y operates loop 1 to control its own phases 120 via the phase control switch 210_Y on the second voltage regulation module card 101 and operates loop 2 to control phases 120 on the first voltage regulation module card 101 via the phase control switch 210_X. It should be appreciated that an analogous backup process can occur if the voltage regulation module controller 110_Y failed on the second voltage regulation module card 101.

FIGS. 4 and 5 depict an example with a third voltage regulation module card 101 having a phase control switch 210_Z according to one or more embodiments. In this example, loop 2 of the voltage regulation module controller 110_Y in the second the voltage regulation module card 101 is connected to the phase control switch 210_Z of the third voltage regulation module card 101.

On the third voltage regulation module card 101, the phase control switch 210_Z is added between the voltage regulation module controller 110_Z (e.g., controller Z) and the phases 120. Control wire 206 connects the phase control switch 210_Z to the voltage regulation module controller 110_Z while control wires 226 connect the phase control switch 210_Z to the phases 120 on the third voltage regulation module card 101. A control wire 212_ZX connects the voltage regulation module controller 110_Z (e.g., controller Z) on the third voltage regulation module card 101 to the phase control switch 210_X on the first voltage regulation module card 101. It is noted that control wire 212_XY, control wire 212_YZ, and control wire 212_ZX can generally be referred to as control wires 212.

As noted herein, during normal operation, the phase control switch 210_X connects loop 1 of the voltage regulation module controller 110_X (e.g., controller X) to the phases 120 on the first voltage regulation module card 101, while unused loop 2 (e.g., idle) is wired such that it is also connected to the phase control switch 210_X but not to the phases 120. During normal operation, the phase control switch 210_Y connects loop 1 of the voltage regulation module controller 110_Y (e.g., controller Y) to the phases 120 on the second voltage regulation module card 101, while unused loop 2 (e.g., idle) is wired such that it is also connected to the phase control switch 210_Y but not to the phases 120. Similarly, during normal operation, the phase control switch 210_Z connects loop 1 to the phases 120 on the third voltage regulation module card 101, while unused loop 2 (e.g., idle) is wired such that it is also connected to the phase control switch 210_Z but not to the phases 120.

As can be seen in FIGS. 4 and 5, loop 2 (having backup image Y) of the voltage regulation module controller 110_X is configured to backup voltage regulation module controller 110_Y via the phase control switch 210_Y. Loop 2 (having backup image Z) of the voltage regulation module controller 110_Y is configured to backup voltage regulation module controller 110_Z via the phase control switch 210_Z. Analogously, loop 2 (having backup image X) of the voltage regulation module controller 110_Z is configured to backup voltage regulation module controller 110_X via the phase control switch 210_X.

Now turning to FIG. 5, a block diagram depicts an example in which the voltage regulation module controller 110_Y (e.g., controller Y) fails on the second voltage regulation module card 101 and the backup controller in the first voltage regulation module card 101 is activated to control the phases 120. In this example, when voltage regulation module controller 110_Y (e.g., controller Y) fails, the phase control switch 210_Y detects and diagnoses the voltage regulation module controller 110_Y as defective. The phase control switch 210_Y is configured to engage connections to voltage regulation module controller 110_X (e.g., controller X). The voltage regulation module controller 110_X takes over functions of the (failed) voltage regulation module controller 110_Y for backup operation. In one or more embodiments, the phase control switch 210_Y may send a control signal (e.g., notification) on control wire 212_XY indicating that voltage regulation module controller 110_Y has failed and voltage regulation module controller 110_X is to take over control of the phases 120 previously controlled by voltage regulation module controller 110_Y. In response to the voltage regulation module controller 110_X receiving the control signal (e.g., as initiation) from the phase control switch 210_Y, the voltage regulation module controller 110_X is configured to retrieve the image Y of loop 2 (from its memory) that corresponds to the phases 120 of the second voltage regulation module card 101 and send a control signal with commands to the phase control switch 210_Y for controlling the power output of the connected phases 120.

The image Y in loop 2 of the voltage regulation module controller 110_X is a replica of the image Y in loop 1 in the failed voltage regulation module controller 110_Y. In one or more embodiments, the voltage regulation module controller 110_X can receive updates to the (backup) image Y in loop 2 from the computer system 50 and/or the voltage regulation module controller 110_Y (e.g., up until failure) such that the replica image Y in loop 2 of the voltage regulation module controller 110_X is ready to backup the image Y in loop 1 of the failed voltage regulation module controller 110_Y. Once the backup has been initiated by the control signal, voltage regulation module controller 110_X operates loop 1 to control its own phases 120 via the phase control switch 210_X on the first voltage regulation module card 101 and operates loop 2 to control phases 120 on the second voltage regulation module card 101 via the phase control switch 210_Y. It should be appreciated that an analogous backup process can occur if the voltage regulation module controller 110_X fails or if the voltage regulation module controller 110_Z fails.

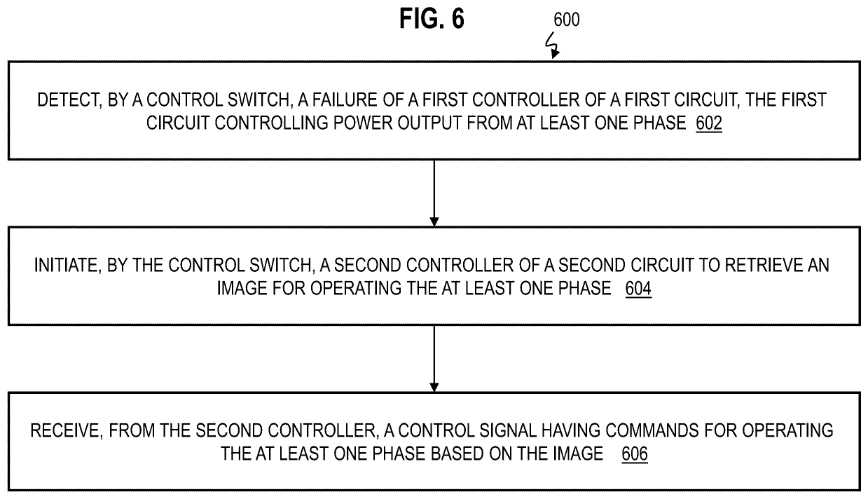

FIG. 6 depicts a flowchart of a computer-implemented method 600 for providing redundant controllers in voltage regulation modules and point-of-load (POL) applications, thereby improving design robustness in accordance with one or more embodiments. Reference can be made to any of the figures discussed herein.

At block 602, the control switch (e.g., one of the phase control switches 210) is configured to detect a failure of a first controller (e.g., one of the voltage regulation module controllers 110_X, 110_Y, and 110_Z) of a first circuit (e.g., one of the first, second, or third voltage regulation module cards 101), the first circuit controlling power output from at least one phase (e.g., phase 120 such as phase 1, phase N-1, and/or phase N).

At block 604, the control switch (e.g., one of the phase control switches 210) is configured to initiate/cause/notify a second controller (e.g., another one of the voltage regulation module controllers 110_X, 110_Y, and 110_Z) of a second circuit (e.g., another one of the first, second, or third voltage regulation module cards 101) to retrieve an image (e.g., one of image X, image Y, and image Z) for operating the at least one phase (e.g., one of the phase control switches 210).

At block 606, the control switch (e.g., one of the phase control switches 210) is configured to receive, from the second controller (e.g., another one of the voltage regulation module controllers 110_X, 110_Y, and 110_Z), a control signal (e.g., on one of the control wires 212) having commands for operating the at least one phase based on the image.

The control switch (e.g., one of the phase control switches 210) is configured to operate the at least one phase to output power (to a load) in accordance with the commands. The commands may include parameters for controlling output power to the load. Example parameters of the images for controlling output power to the load may include reference current, reference voltage, temperature, PWM values, duty cycle ratio, output voltage, output current, temperature, etc.

The second controller (e.g., another one of the voltage regulation module controllers 110_X, 110_Y, and 110_Z) comprises a first loop (e.g., loop 1) and a second loop (e.g., loop 2). The second controller (e.g., another one of the voltage regulation module controllers 110_X, 110_Y, and 110_Z) is configured to utilize the first loop (e.g., loop 1) to operate a primary phase (e.g., another phase 120) and the second loop (e.g., loop 2) to serve as a backup to the first controller (e.g., one of the voltage regulation module controllers 110_X, 110_Y, and 110_Z).

The second loop comprises the image (e.g., one of image X, image Y, and image Z) for operating the at least one phase. The first controller comprises an original image (e.g., one of image X, image Y, and image Z) for operating the at least one phase. The second controller comprises the image (e.g., one of image X, image Y, and image Z) as a copy of an original image of the first controller.

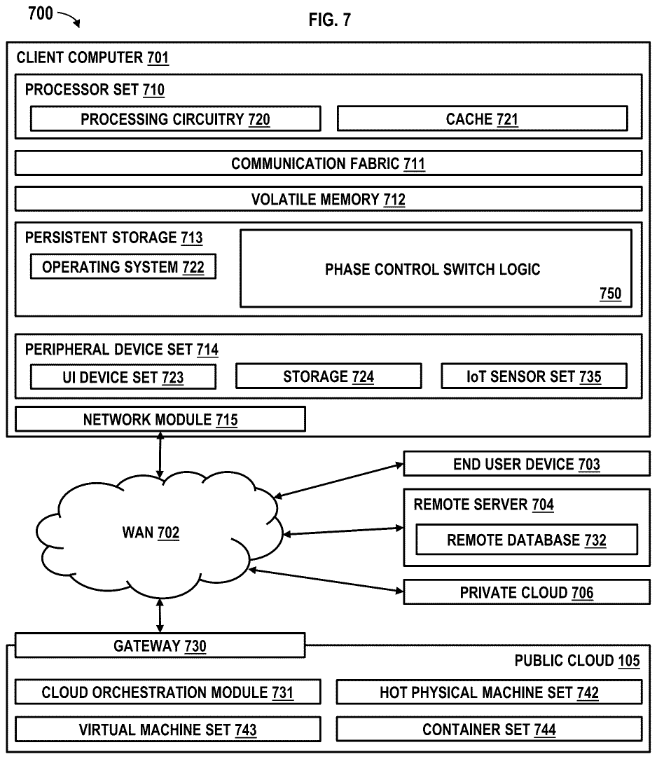

It is noted that the phase control switches 210_X, phase control switch 210_Y, and phase control switch 210_Z can including any features and functionality of a computer 701 (depicted in FIG. 7) in order to operate with the logic as discussed herein. In accordance with one or more embodiments, the phase control switches 210_X, phase control switch 210_Y, and phase control switch 210_Z can include phase control switch logic 750 to implement the functionality discussed herein. Also, the voltage regulation module controllers 110_X, 110_Y, and 110_Z can include any suitable features and functionality of the computer 701 to operate as discussed herein. The computer system 50 may include any suitable features and functionality of the computer 701.

FIG. 7 illustrates a computing environment 700, according to an embodiment. Computing environment 700 contains an example of an environment for the execution of at least some of the computer code involved in performing the inventive methods, such as a phase control switch logic 750 for employing redundant controllers to improve design robustness in voltage regulation modules. In addition to the phase control switch logic 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and phase control switch logic 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in the phase control switch logic 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open-source Portable Operating System Interface-type operating systems that employ a kernel. The code included in the phase control switch logic 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

According to one or more embodiments, the computing environment 700 can provide for remote data storage. For example, the computer 701 can be a cloud storage system or other suitable system for storing data that is accessible to a user remotely, such as by accessing the computer 701 using the end user device 703. That is, a user can send a user operation (also referred to as a “user request”) from the end user device 703 to the computer 701 via the WAN 702. Although the user operation may appear to be simple, such as uploading an object to a cloud storage system, the complications of operating a cloud computing system often have side effects and produce ancillary data, which may be consumed by both the operator of the system (e.g., the computer 701) and by users or other components of the cloud architecture (e.g., the computing environment 700). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the oner of the entity is also updated).

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
detecting, by a control switch, a failure of a first controller of a first circuit, the first circuit controlling power output from at least one phase;
initiating, by the control switch, a second controller of a second circuit to retrieve an image for operating the at least one phase; and
receiving, from the second controller, a control signal having commands for operating the at least one phase based on the image.

2. The computer-implemented method of claim 1, wherein the control switch is configured to operate the at least one phase to output power in accordance with the commands.

3. The computer-implemented method of claim 1, wherein the second controller comprises a first loop and a second loop.

4. The computer-implemented method of claim 1, wherein the second controller is configured to utilize a first loop to operate a primary phase and a second loop to serve as a backup to the first controller.

5. The computer-implemented method of claim 4, wherein the second loop comprises the image for operating the at least one phase.

6. The computer-implemented method of claim 1, wherein the first controller comprises an original image for operating the at least one phase.

7. The computer-implemented method of claim 1, wherein the second controller comprises the image as a copy of an original image of the first controller.

8. A control switch comprising:
a memory comprising computer readable instructions; and
a processing circuitry for executing the computer readable instructions, the computer readable instructions controlling the processing circuitry to perform operations comprising:
detecting a failure of a first controller of a first circuit, the first circuit controlling power output from at least one phase;
initiating a second controller of a second circuit to retrieve an image for operating the at least one phase; and
receiving, from the second controller, a control signal having commands for operating the at least one phase based on the image.

9. The control switch of claim 8, wherein the processing circuitry is configured to operate the at least one phase to output power in accordance with the commands.

10. The control switch of claim 8, wherein the second controller comprises a first loop and a second loop.

11. The control switch of claim 8, wherein the second controller is configured to utilize a first loop to operate a primary phase and a second loop to serve as a backup to the first controller.

12. The control switch of claim 11, wherein the second loop comprises the image for operating the at least one phase.

13. The control switch of claim 8, wherein the first controller comprises an original image for operating the at least one phase.

14. The control switch of claim 8, wherein the second controller comprises the image as a copy of an original image of the first controller.

15. A system comprising:
a first circuit comprising a control switch and a first controller; and
a plurality of circuits, the first circuit being included in the plurality of circuits;
wherein the control switch is configured to:
detect a failure of the first controller of the first circuit, the first circuit controlling power output from at least one phase;
initiate a second controller of a second circuit of the plurality of circuits to retrieve an image for operating the at least one phase; and
receive, from the second controller, a control signal having commands for operating the at least one phase based on the image.

16. The system of claim 15, wherein the control switch is configured to operate the at least one phase to output power in accordance with the commands.

17. The system of claim 15, wherein the second controller comprises a first loop and a second loop.

18. The system of claim 15, wherein the second controller is configured to utilize a first loop to operate a primary phase and a second loop to serve as a backup to the first controller.

19. The system of claim 18, wherein the second loop comprises the image for operating the at least one phase.

20. The system of claim 18, wherein:
the first controller comprises an original image for operating the at least one phase; and
the second controller comprises the image as a copy of the original image of the first controller.
